(19) United States
(12) Patent Application Publication
(10) Pub. No.: US 2011/0269663 A1
(43) Pub. Date: Nov. 3, 2011

(54) FABRIC CONDITIONERS

(76) Inventors: Elizabeth Ann Clowes, Wirral (GB); Vincent Charles Mole, Wirral (GB); Mark Nicholas Newman, Wirral (GB); Janette Perry, Wirral (GB)

(21) Appl. No.: 13/142,599

(22) PCT Filed: Dec. 24, 2009
(86) PCT No.: PCT/EP09/67917

§ 371 Date: Jun. 29, 2011

(30) Foreign Application Priority Data
Jan. 6, 2009 (EP) PCT/EP2009/050076

(51) Int. Cl. C11D 3/60

(52) U.S. Cl. 510/515

(57) ABSTRACT

A fabric conditioner composition comprising a polymer and a fabric softening active, characterised in that the polymer is a crosslinked water swellable cationic copolymer of at least one cationic monomer and optionally other monomers selected from non-ionic and anionic monomers, characterized in that the polymer comprises less than 25% of water soluble polymers, by total weight of the polymer, and a cross-linking agent concentration of from 500 ppm to 5000 ppm relative to the polymer.

### TECHNICAL FIELD

The present invention relates to stable fabric conditioner compositions containing a viscosity modifying polymer.

### BACKGROUND AND PRIOR ART

The use of polymers in fabric conditioners to control properties such as viscosity and appearance is well known and is advantageous because it contributes to the overall perception of quality by the consumer. The viscosity of a fabric conditioner can be increased in a number of ways such as increasing the level of softening active or by the addition of a polymer. The use of additional active has a significant cost associated with it. The use of polymer to build the viscosity of a fabric conditioner cost effectively, without any negative impact on performance, has proven difficult to achieve. One problem resides in insufficient “weight efficiency”, which is defined as the degree of viscosity that a fixed amount of polymer builds in a composition, compared to a composition which does not contain any polymer. Good weight efficiency is desirable because it enables the use of a lower amount of polymer to achieve a certain viscosity, compared with a less weight efficient polymer. Further, the addition of cationic polymers to fabric conditioner formulations can lead to an increase in the redeposition of soils onto the wash load resulting in a loss of whiteness. Moreover, the use of such polymers can lead to uneven redeposition of soil leading to a noticeable blotchy appearance on fabrics.

Standard cationic polymeric thickeners are crosslinked water swellable polymers, such as those disclosed in WO 90/12862 (BP Chemicals), which discloses the use of lightly (5-45 ppm) cross-linked cationic thickeners, or US 2002/0132749 (Colgate-Palmolive Company) and Research Disclosure 429116, which disclose the use of heavily cross-linked cationic thickeners.

More specifically, the use of commonly used commercially available cationic based polymers such as Flosoft222 (ex SNF) and Rheovis (ex Ciba) achieve an increase in the viscosity of the fabric conditioner. However, we have found that, when incorporated into a fabric conditioning composition, these polymers, and others like them, lead to unacceptable levels of soil re-deposition, unless used at very low levels. Therefore, the maximum viscosity that can be achieved, whilst maintaining a product that has no consumer related negatives, is limited by the level of polymer that results in an acceptable level of negative side effects.

We have now found that fabric conditioner compositions comprising cationic polymeric thickeners exhibiting a low fraction of water soluble polymers (below 25% by weight) and a relatively high level of cross-linking, demonstrate an unexpectedly dramatic improvement in their redeposition profiles. These new polymers differ from standard cationic polymeric thickeners used in fabric softeners which have all been found to exhibit a much higher fraction of water soluble polymers.

The combination of a low level of water soluble polymers and increased level of cross-linking results in a markedly improved weight efficiency and corresponding reduction in the re-deposition of soil. A higher level of polymer can therefore be incorporated into a fabric conditioner formulation and a higher viscosity can thus be achieved for the same amount of polymer. Further advantages are obtained in the overall performances in a fabric softening composition of the present invention versus a similar composition including standard cationic polymeric thickeners and more particularly, a higher stability upon aging.

### STATEMENT OF THE INVENTION

In a first aspect of the invention, there is provided a fabric conditioner composition comprising a polymer and a fabric softening active, characterised in that the polymer is a crosslinked water swellable cationic polymer of at least one cationic monomer and optionally other monomers selected from non-ionic and anionic monomers, characterized in that the polymer comprises less than 25% of water soluble polymeric chains, by total weight of the polymer, and a cross-linking agent concentration of from 500 ppm to 5000 ppm relative to the polymer.

In a second aspect, there is provided a process for preparing a composition as defined in the first aspect of the invention which comprises the steps of:—heating water to a temperature of from 40 to 50° C.; adding the polymer to the water and mixing; melting the softening active to form a melt; adding the melt to the water; and then adjusting the pH.

In a third aspect, there is provided a use of a composition as defined in the first aspect of the invention to condition textiles.

A fourth aspect of the invention provides a use of a polymer as defined hereinbelow in a fabric conditioning composition.

### DETAILED DESCRIPTION OF THE INVENTION

### The Polymer

The polymer for use in the compositions of the invention is a crosslinked water swellable cationic copolymer having at least one cationic monomer and optionally other non-ionic and/or anionic monomers. Preferably the polymer is a copolymer of acrylamide and trimethylaminoethylmethacrylate chloride.

The polymer comprises less than 25% of water soluble polymeric chains by weight of the total polymer, preferably less than 20%, and most preferably less than 15%, for example, from 0 to 25%, preferably from 5 to 20%, more preferably from 8 to 15% by weight of the total polymer. The polymer also comprises a cross-linking agent concentration of from 500 ppm to 5000 ppm relative to the polymer, preferably from 750 ppm to 5000 ppm, more preferably from 1000 to 4500 ppm.

According to the invention, the cross-linking agent concentration must be higher than about 500 ppm relative to the polymer, and preferably higher than about 750 ppm when the crosslinking agent used is the methylene bisacrylamide, or concentrations of other cross-linking agents that lead to equivalent cross-linking levels of from 10 to 10,000 ppm.

A nonionic surfactant may be added to the polymer dispersion to improve its dispersability and/or handleability.

The polymers of the invention are prepared in conventional water in oil emulsion by polymerising at least one cationic monomer, and optionally other non-ionic and/or anionic monomers, in the presence of a cross-linking agent and optionally of a chain transfer agent.

The polymers are made by reverse phase polymerisation of the monomer or monomers blend in the presence of cross linker(s). They are formed from monoethylenically unsaturated monomer(s), that is either a water soluble cationic monomer or a blend of cationic monomers that may consist of cationic monomer(s) alone, or may comprise a mixture of cationic monomer (or blend of cationic monomers) and from 0 to 50 mole % preferably from 5 to 50 mole % of non-ionic and/or anionic monomer(s).

Cationic monomers used for the invention are selected from the group consisting of the following monomers and derivatives and their quaternary or acid salts: dimethylaminopropylmethacrylamide, dimethylaminopropylacrylamide, diallylamine, methyldiallylamine, dialkylaminoalkyl-acrylates and methacrylates, dialkylaminoalkyl-acrylamides or -methacrylamides.

Following is a non-restrictive list of monomers performing a non-ionic function: acrylamide, methacrylamide, N-Alkyl acrylamide, N-vinyl pyrrolidone, N-vinyl formamide, N-vinyl acetamide, vinylacetate, vinyl alcohol, acrylate esters, allyl alcohol.

Following is a non-restrictive list of monomers performing an anionic function: acrylic acid, methacrylic acid, itaconic acid, crotonic acid, maleic acid, fumaric acid, as well as monomers performing sulfonic acid or phosphonic acid functions, such as 2-acrylamido-2-methyl propane sulfonic acid (ATBS) etc.

The monomers may also contain hydrophobic groups.

Following is a non-restrictive list of cross-linking agents: methylene bisacrylamide (MBA), ethylene glycol diacrylate, polyethylene glycol dimethacrylate, diacrylamide, triallylamine, cyanomethylacrylate, vinyl oxyethylacrylate or methacrylate and formaldehyde, glyoxal, compounds of the glycidyl ether type such as ethyleneglycol diglycidyl ether, or the epoxydes or any other means familiar to the expert permitting cross-linking.

By way of pre-eminent preference the cross-linking rate preferably ranges from 800 to 5000 ppm (on the basis of MBA) relative to the polymer or equivalent cross-linking with a cross-linking agent of different efficiency.

As described in US 2002/0132749 and Research Disclosure 429116, the degree of non-linearity can additionally be controlled by the inclusion of chain transfer agents (such as isopropyl alcohol, sodium hypophosphite, mercaptoethanol) in the polymerisation mixture in order to control the polymeric chain's length and the cross-linking density.

It is understood that it is essential according to the invention that the polymer be prepared by means of a reverse phase oil-in-water emulsion polymerization. This means that when polymerized, the aqueous monomer(s) is emulsified into a suitable oil phase, in the presence of a water-in-oil emulsifier. Emulsifiers, polymeric stabilisers, non-aqueous liquids and other reverse phase polymerisation materials and process details are described in, for instance, EP 126528.

It is well known that the reverse phase emulsion so obtained can be dehydrated and the resulting polymeric thickener concentration in the reverse emulsion is between 15 to 65 percent by weight.

The liquid product resulting from the emulsion polymerisation is generally used as such, without separation of the polymer particles from it, but if desired dried polymer particles may be isolated by all known techniques. Those processes are consisting of isolating the active matter (i.e. the polymer) from other constituents of the emulsion. Processes such as the following may be used:
precipitation in a non-solvent medium such as acetone, methanol, and other polar solvents,
simple filtration then permits isolation of the polymer particle,
azeotropic distillation in the presence of an agglomerating agent and stabilizing polymer which makes it possible to obtain agglomerates which are easily isolated by filtration before drying of the particle is undertaken,
“spray drying,” or drying by atomization or pulverization, this process consists of creating a cloud of fine droplets of emulsion in a stream of hot air for a controlled period.

When the polymer-in-oil emulsion that results from reverse phase polymerisation is used as such and directly added to water to form an aqueous composition, it is done in a conventional manner in the presence of oil-in-water emulsifier.

The expert will understand optimization of the polymerization conditions by reading this description and because of his individual knowledge, or as a result of simple routine tests, such that the final polymer has a water-soluble polymer fraction ranging below about 25% by weight of the total polymer (as determined by a metering method such as that described on page 8 of patent EP 343840).

The expert will know in particular how to estimate, on the basis of his own knowledge, the amount of chain transfer agent and cross-linking to be used in order to obtain a final polymer having an adequate fraction of water-soluble polymer and the desired rheology.

The cationic polymeric thickeners of the present invention were found not to interfere with the softening agent and to be stable over all storage regimes at pH values from 1 to 6.

The amount of polymer used in the compositions of the invention is suitably from 0.001 to 5 wt %, preferably from 0.005 to 4 wt %. Where the composition is a concentrated fabric conditioning composition, i.e. comprising a softening active in an amount of from 8.5 to 20 wt %, by weight of the total composition, then the polymer is preferably present in an amount of from 0.01 to 0.2 wt %, more preferably from 0.02 to 0.1 wt %, by weight of the total composition.

Where the composition comprises a lower level of softening active, for example in an amount of from 2 to 8 wt %, by weight of the total composition, then the polymer is preferably present in an amount of from 0.001 to 0.5, preferably from 0.15 to 0.35 wt %, by weight of the total composition.

The present invention is intended to cover the use of a crosslinked water swellable cationic copolymer as described above in a fabric conditioning composition. The copolymer causes thickening of the fabric conditioning composition. Suitable fabric conditioning compositions are described below.

### The Fabric Conditioning Agent

Any suitable fabric conditioning agent may be used in the compositions of the present invention. The conditioning agents (also referred to herein as a fabric softening active) may be cationic or non-ionic.

The fabric conditioning compositions of the invention may be dilute or concentrated. Dilute products typically contain up to about 8%, preferably from 2 to 8% by weight of softening active, whereas concentrated products may contain from about 8 to about 50%, preferably from 8 to 25% by weight active. Compositions of more than about 25% by weight of active are defined as “super concentrated”, depending on the active system, and are also intended to be covered by the present invention. The fabric conditioning agent may, for example, be used in amounts of from 0.5% to 35%, preferably from 2% to 30% more preferably from 5% to 25% and most preferably from 8% to 20% by weight of the composition.

The preferred softening active for use in rinse conditioner compositions of the invention is a quaternary ammonium compound (QAC). The preferred quaternary ammonium fabric conditioner for use in compositions of the present invention are the so called “ester quats”.

Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri-ester forms of the compound where the di-ester linked component comprises no more than 70% by weight of the fabric softening compound, preferably no more than 60%, e.g. 55%, or 45% of the fabric softening compound and at least 10% of the monoester linked component, for example 11% monoester. A preferred hardened type of active has a typical mono:di:tri ester distribution of from 18 to 22 mono: from 58 to 62 di: from 18 to 22 tri; for example 20:60:20. A soft TEA quat may have a typical mono:di:tri ester distribution of from 25 to 45%, preferably from 30 to 40% mono: from 45 to 60%, preferably from 50 to 55% di: and from 5 to 25%, preferably from 10 to 15% tri; for example 40:60:10.

A first group of quaternary ammonium compounds (QACs) suitable for use in the present invention is represented by formula (I):

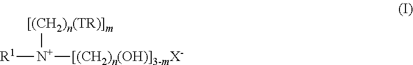

wherein each R is independently selected from a C₅₋₃₅ alkyl or alkenyl group; R¹ represents a C₁₋₄ alkyl, C₂₋₄ alkenyl or a C₁₋₄ hydroxyalkyl group; T is generally O—CO. (i.e. an ester group bound to R via its carbon atom), but may alternatively be CO—O (i.e. an ester group bound to R via its oxygen atom); n is a number selected from 1 to 4; m is a number selected from 1, 2, or 3; and X⁻ is an anionic counter-ion, such as a halide or alkyl sulphate, e.g. chloride or methylsulphate. Di-esters variants of formula I (i.e. m=2) are preferred and typically have mono- and tri-ester analogues associated with them. Such materials are particularly suitable for use in the present invention.

Especially preferred agents are preparations which are rich in the di-esters of triethanolammonium methylsulphate, otherwise referred to as “TEA ester quats”.

Commercial examples include Stepantex™ UL85, ex Stepan, Prapagen™ TQL, ex Clariant, and Tetranyl™ AHT-1, ex Kao, (both di-[hardened tallow ester] of triethanolammonium methylsulphate), AT-1 (di-[tallow ester] of triethanolammonium methylsulphate), and L5/90 (di-[palm ester] of triethanolammonium methylsulphate), both ex Kao, and Rewoquat™ WE15 (a di-ester of triethanolammonium methylsulphate having fatty acyl residues deriving from C₁₀-C₂₀ and C₁₆-C₁₈ unsaturated fatty acids), ex Witco Corporation.

Also, soft quaternary ammonium actives such as Stepantex VK90, Stepantex VT90, SP88 (ex-Stepan), Ceca Noramine, Prapagen TQ (ex-Clariant), Dehyquart AU-57 (ex-Cognis), Rewoquat WE18 (ex-Degussa) and Tetranyl L190 P, Tetranyl L190 SP and Tetranyl L190 S (all ex-Kao) are suitable.

A second group of QACs suitable for use in the invention is represented by formula (II):

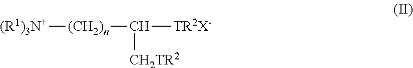

wherein each R¹ group is independently selected from C₁₄ alkyl, hydroxyalkyl or C₂₋₄ alkenyl groups; and wherein each R² group is independently selected from C₈₋₂₈ alkyl or alkenyl groups; and wherein n, T, and X⁻ are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of QACs suitable for use in the invention is represented by formula (III):

(R¹)₂—N⁺—[(CH₂)ₙ-T-R²]₂X⁻ (III)

wherein each R¹ group is independently selected from C₁₋₄ alkyl, or C₂₋₄ alkenyl groups; and wherein each R² group is independently selected from C₈₋₂₈ alkyl or alkenyl groups; and n, T, and X⁻ are as defined above. Preferred materials of this third group include bis(2-tallowoyloxyethyl)dimethyl ammonium chloride and hardened versions thereof.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulphate. Such ester-linked triethanolamine quaternary ammonium compound comprise unsaturated fatty chains.

Iodine value as used in the context of the present invention refers to the measurement of the degree of unsaturation present in a material by a method of nmr spectroscopy as described in Anal. Chem., 34, 1136 (1962) Johnson and Shoolery.

Iodine value is defined as the number of grams of iodine absorbed per 100 g of the test material. Olefinic materials absorb 1 gram of iodine per atom of olefinic hydrogen. Hence measurement can be converted to the equivalent Iodine Value. The hydrogen nmr spectrum at 360 MHz is obtained for the test material. The integral intensity, Iₛ, of the band derived from olefinic hydrogen in the alkyl chain and the integral intensity, Iₘ, of the band derived from terminal methyl groups in the alkyl chains are measured.

The number of olefinic hydrogens per molecule is given by:

$$\frac{{I}_{s}}{{I}_{m}} \times 6$$

and the Iodine Value is given by:

$$\frac{{I}_{s} \times 127 \times 100 \times 6}{{I}_{m} \times MMW}$$

where MMW is the mean molecular weight of the test material.

A further type of softening compound is a non-ester quaternary ammonium material represented by formula (IV):—

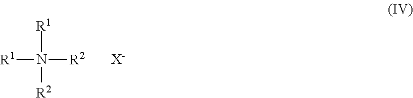

wherein each R¹ group is independently selected from C₁₋₄ alkyl, hydroxyalkyl or C₂₋₄ alkenyl groups; R² group is independently selected from C₈₋₂₈ alkyl or alkenyl groups, and X⁻ is as defined above.

The compositions of the invention may contain a non-cationic softening material, which is preferably an oily sugar derivative. An oily sugar derivative is a liquid or soft solid derivative of a cyclic polyol (CPE) or of a reduced saccharide (RSE), said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

Advantageously, the CPE or RSE does not have any substantial crystalline character at 20° C. Instead it is preferably in a liquid or soft solid state as herein defined at 20° C.

The liquid or soft solid (as hereinafter defined) CPEs or RSEs suitable for use in the present invention result from 35 to 100% of the hydroxyl groups of the starting cyclic polyol or reduced saccharide being esterified or etherified with groups such that the CPEs or RSEs are in the required liquid or soft solid state. These groups typically contain unsaturation, branching or mixed chain lengths.

Typically the CPEs or RSEs have 3 or more ester or ether groups or mixtures thereof, for example 3 to 8, especially 3 to 5. It is preferred if two or more of the ester or ether groups of the CPE or RSE are independently of one another attached to a C₈ to C₂₂ alkyl or alkenyl chain. The C₈ to C₂₂ alkyl or alkenyl groups may be branched or linear carbon chains.

Preferably 35 to 85% of the hydroxyl groups, most preferably 40-80%, even more preferably 45-75%, such as 45-70% are esterified or etherified.

Preferably the CPE or RSE contains at least 35% tri or higher esters, eg at least 40%.

The CPE or RSE has at least one of the chains independently attached to the ester or ether groups having at least one unsaturated bond. This provides a cost effective way of making the CPE or RSE a liquid or a soft solid. It is preferred if predominantly unsaturated fatty chains, derived from, for example, rape oil, cotton seed oil, soybean oil, oleic, tallow, palmitoleic, linoleic, erucic or other sources of unsaturated vegetable fatty acids, are attached to the ester/ether groups.

These chains are referred to below as the ester or ether chains (of the CPE or RSE).

The ester or ether chains of the CPE or RSE are preferably predominantly unsaturated. Preferred CPEs or RSEs include sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose tiroleate, glucose tetraoleate, xylose trioleate, or sucrose tetra-, tri-, penta- or hexa-esters with any mixture of predominantly unsaturated fatty acid chains. The most preferred CPEs or RSEs are those with monosaturated fatty acid chains, i.e. where any polyunsaturation has been removed by partial hydrogenation. However some CPEs or RSEs based on polyunsaturated fatty acid chains, eg sucrose tetralinoleate, may be used provided most of the polyunsaturation has been removed by partial hydrogenation.

The most highly preferred liquid CPEs or RSEs are any of the above but where the polyunsaturation has been removed through partial hydrogenation.

Preferably 40% or more of the fatty acid chains contain an unsaturated bond, more preferably 50% or more, most preferably 60% or more. In most cases 65% to 100%, e.g. 65% to 95% contain an unsaturated bond.

CPEs are preferred for use with the present invention. Inositol is a preferred example of a cyclic polyol. Inositol derivatives are especially preferred.

In the context of the present invention, the term cyclic polyol encompasses all forms of saccharides. Indeed saccharides are especially preferred for use with this invention. Examples of preferred saccharides for the CPEs or RSEs to be derived from are monosaccharides and disaccharides.

Examples of monosaccharides include xylose, arabinose, galactose, fructose, sorbose and glucose. Glucose is especially preferred. Examples of disaccharides include maltose, lactose, cellobiose and sucrose. Sucrose is especially preferred. An example of a reduced saccharide is sorbitan.

The liquid or soft solid CPEs can be prepared by methods well known to those skilled in the art. These include acylation of the cyclic polyol or reduced saccharide with an acid chloride; trans-esterification of the cyclic polyol or reduced saccharide fatty acid esters using a variety of catalysts; acylation of the cyclic polyol or reduced saccharide with an acid anhydride and acylation of the cyclic polyol or reduced saccharide with a fatty acid. See for instance U.S. Pat. No. 4,386,213 and AU 14416/88 (both P&G).

It is preferred if the CPE or RSE has 3 or more, preferably 4 or more ester or ether groups. If the CPE is a disaccharide it is preferred if the disaccharide has 3 or more ester or ether groups. Particularly preferred CPEs are esters with a degree of esterification of 3 to 5, for example, sucrose tri, tetra and penta esters.

Where the cyclic polyol is a reducing sugar it is advantageous if each ring of the CPE has one ether or ester group, preferably at the C₁ position. Suitable examples of such compounds include methyl glucose derivatives.

Examples of suitable CPEs include esters of alkyl(poly)glucosides, in particular alkyl glucoside esters having a degree of polymerisation from 1 to 2.

The length of the unsaturated (and saturated if present) chains in the CPE or RSE is C₈-C₂₂, preferably C₁₂-C₂₂. It is possible to include one or more chains of C₁-C₈, however these are less preferred.

The liquid or soft solid CPEs or RSEs which are suitable for use in the present invention are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the signal with a T₂ of less than 100 μs is considered to be a solid component and any component with T₂≧100 μs is considered to be a liquid component.

For the CPEs and RSEs, the prefixes (e.g. tetra and penta) only indicate the average degrees of esterification. The compounds exist as a mixture of materials ranging from the monoester to the fully esterified ester. It is the average degree of esterification which is used herein to define the CPEs and RSEs.

The HLB of the CPE or RSE is typically between 1 and 3.

Where present, the CPE or RSE is preferably present in the composition in an amount of 0.5-50% by weight, based upon the total weight of the composition, more preferably 1-30% by weight, such as 2-25%, eg 2-20%.

The CPEs and RSEs for use in the compositions of the invention include sucrose tetraoleate, sucrose pentaerucate, sucrose tetraerucate and sucrose pentaoleate.

### Co-Softeners and Fatty Complexinq Agents

Co-softeners may be used. When employed, they are typically present at from 0.1 to 20% and particularly at from 0.5 to 10%, based on the total weight of the composition. Preferred co-softeners include fatty esters, and fatty N-oxides. Fatty esters that may be employed include fatty monoesters, such as glycerol monostearate, fatty sugar esters, such as those disclosed WO 01/46361 (Unilever).

The compositions of the present invention may comprise a fatty complexing agent.

Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include hardened tallow fatty acid (available under the tradename Pristerene™, ex Uniqema). Preferred fatty alcohols include hardened tallow alcohol (available under the tradenames Stenol™ and Hydrenol™, ex Cognis and Laurex™ CS, ex Albright and Wilson).

The fatty complexing agent is preferably present in an amount greater than 0.3 to 5% by weight based on the total weight of the composition. More preferably, the fatty component is present in an amount of from 0.4 to 4%. The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

### Non-Ionic Surfactant

The compositions may further comprise a nonionic surfactant. Typically these can be included for the purpose of stabilising the compositions. These are particularly suitable for compositions comprising hardened quaternary ammonium compounds.

Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water soluble surfactants of the general formula:

R—Y—(C₂H₄O)_{z}—CH₂—CH₂—OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above or can be hydrogen; and Z is at least about 8, preferably at least about 10 or 11.

Preferably the nonionic surfactant has an HLB of from about 7 to about 20, more preferably from 10 to 18, e.g. 12 to 16. Genapol™ C200 (Clariant) based on coco chain and 20 EO groups is an example of a suitable nonionic surfactant.

If present, the nonionic surfactant is present in an amount from 0.01 to 10%, more preferably 0.1 to 5 by weight, based on the total weight of the composition.

### Shading Dyes

Optional shading dyes can be used. Preferred dyes are violet or blue. Suitable and preferred classes of dyes are discussed below. Moreover the unsaturated quaternary ammonium compounds are subject to some degree of UV light and/or transition metal ion catalysed radical auto-oxidation, with an attendant risk of yellowing of fabric. The present of a shading dye also reduces the risk of yellowing from this source.

### Direct Dyes

Direct dyes (otherwise known as substantive dyes) are the class of water soluble dyes which have a affinity for fibres and are taken up directly. Direct violet and direct blue dyes are preferred.

Preferably the dye are bis-azo or tris-azo dyes are used.

Most preferably, the direct dye is a direct violet of the following structures:

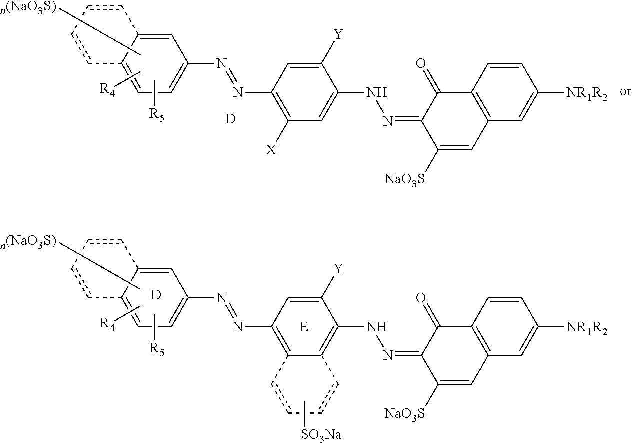

wherein:
ring D and E may be independently naphthyl or phenyl as shown;
R₁ is selected from: hydrogen and C₁-C₄-alkyl, preferably hydrogen;

R₂ is selected from: hydrogen, C₁-C₄-alkyl, substituted or unsubstituted phenyl and substituted or unsubstituted naphthyl, preferably phenyl;

R₃ and R₄ are independently selected from: hydrogen and C1-C4-alkyl, preferably hydrogen or methyl;
X and Y are independently selected from: hydrogen, C1-C4-alkyl and C1-C4-alkoxy; preferably the dye has X=methyl; and, Y=methoxy and n is 0, 1 or 2, preferably 1 or 2.

Preferred dyes are direct violet 7, direct violet 9, direct violet 11, direct violet 26, direct violet 31, direct violet 35, direct violet 40, direct violet 41, direct violet 51, and direct violet 99. Bis-azo copper containing dyes such as direct violet 66 may be used.

The benzidene based dyes are less preferred.

Preferably the direct dye is present at 0.00001 wt % to 0.0010 wt % of the formulation.

In another embodiment the direct dye may be covalently linked to the photo-bleach, for example as described in WO2006/024612.

### Acid Dyes

Cotton substantive acid dyes give benefits to cotton containing garments. Preferred dyes and mixes of dyes are blue or violet. Preferred acid dyes are: (i) azine dyes, wherein the dye is of the following core structure:

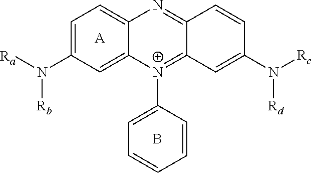

wherein Rₐ, R_{b}, R_{c} and R_{d} are selected from: H, an branched or linear C1 to C7-alkyl chain, benzyl a phenyl, and a naphthyl;
the dye is substituted with at least one SO₃⁻ or —COO⁻ group;
the B ring does not carry a negatively charged group or salt thereof;
and the A ring may further substituted to form a naphthyl;
the dye is optionally substituted by groups selected from: amine, methyl, ethyl, hydroxyl, methoxy, ethoxy, phenoxy, Cl, Br, I, F, and NO₂.

Preferred azine dyes are: acid blue 98, acid violet 50, and acid blue 59, more preferably acid violet 50 and acid blue 98.

Other preferred non-azine acid dyes are acid violet 17, acid black 1 and acid blue 29.

Preferably the acid dye is present at 0.0005 wt % to 0.01 wt % of the formulation.

### Hydrophobic Dyes

The composition may comprise one or more hydrophobic dyes selected from benzodifuranes, methine, triphenylmethanes, napthalimides, pyrazole, napthoquinone, anthraquinone and mono-azo or di-azo dye chromophores. Hydrophobic dyes are dyes which do not contain any charged water solubilising group. Hydrophobic dyes may be selected from the groups of disperse and solvent dyes. Blue and violet anthraquinone and mono-azo dye are preferred.

Preferred dyes include solvent violet 13, disperse violet 27 disperse violet 26, disperse violet 28, disperse violet 63 and disperse violet 77.

Preferably the hydrophobic dye is present at 0.0001 wt % to 0.005 wt % of the formulation.

### Basic Dyes

Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International.

Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141.

### Reactive Dyes

Reactive dyes are dyes which contain an organic group capable of reacting with cellulose and linking the dye to cellulose with a covalent bond. They deposit onto cotton.

Preferably the reactive group is hydrolysed or reactive group of the dyes has been reacted with an organic species such as a polymer, so as to the link the dye to this species. Dyes may be selected from the reactive violet and reactive blue dyes listed in the Colour Index International.

Preferred examples include reactive blue 19, reactive blue 163, reactive blue 182 and reactive blue, reactive blue 96.

### Dye Conjugates

Dye conjugates are formed by binding direct, acid or basic dyes to polymers or particles via physical forces.

Dependent on the choice of polymer or particle they deposit on cotton or synthetics. A description is given in WO2006/055787. They are not preferred.

Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof.

### Further Optional Ingredients

The compositions of the invention may contain one or more other ingredients. Such ingredients include perfumes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colourants, sunscreens, anti-corrosion agents, drape imparting agents, anti-static agents, antifoams, sequestrants and ironing aids. The products of the invention may contain pearlisers and/or opacifiers.

### Product Form

The compositions of the present invention are rinse-added softening compositions suitable for use in a laundry process.

The compositions are preferably liquids.

The liquid compositions have a pH ranging from about 2.5 to 6, preferably from about 2.5 to 4.5, most preferably about 2.5 to 2.8. The compositions of the invention may also contain pH modifiers such as hydrochloric acid or lactic acid.

A composition for use in the invention is preferably in liquid form. The composition may be a concentrate to be diluted in a solvent, including water, before use. The composition may also be a ready-to-use (in-use) composition. Preferably the composition is provided as a ready to use liquid comprising an aqueous phase. The aqueous phase may comprise water-soluble species, such as mineral salts or short chain (C₁₋₄) alcohols.

The composition is preferably for use in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation. It is also possible for the compositions of the present invention to be used in industrial laundry operations, e.g. as a finishing agent for softening new clothes prior to sale to consumers.

### Preparation of the Compositions of the Invention

The compositions of the invention may typically be made by combining a melt comprising the fabric softening active with an aqueous phase. The polymer may be combined with the water phase, or it may be post dosed into the composition after combination of the melt and water phase.

A preferred method of preparation is as follows:—
1. Heat water to about 40 to 50° C., preferably about 45° C.
2. Add the polymer to the water slowly, preferably over about 1 minute with stirring.
3. Mix thoroughly, preferably for from 10 to 15 minutes.
4. Add any minor ingredients, such as antifoams, sequestrants and preservatives.
5. Melt the softening active and fatty alcohol together to form a co-melt.
6. Add the co-melt to the heated water.
7. Add acid to the preferred pH, if required.
8. Add dyes and perfumes.
9. Cool.
   Alternatively, but less preferably, the acid may be added at step 4 and/or the minor ingredients may be added after step 6.

### EXAMPLES

Embodiments of the invention will now be illustrated by the following non-limiting examples. Further modifications will be apparent to the person skilled in the art.

Examples of the invention are represented by a number. Comparative examples are represented by a letter.

### Example 1

### Preparation of a Cationic Polymer for Use in the Present Invention

An aqueous phase of water soluble polymer was prepared by admixing together the following components:
47.0 parts of methyl chloride quaternised dimethylaminoethylmethacrylate
6.0 parts of acrylamide
0.03 part penta sodium diethylene triamine penta acetic acid
14 parts of water,
0.03 part of methylene-bis-acrylamide,
0.4 part of sodium formiate,
pH was adjusted to between 4.0 and 6.0 with citric acid

An oil phase was prepared by admixing together the following components:
2.0 parts of sorbitan mono-oleate,
5.5 parts of a polymeric stabiliser,
19.0 parts of white mineral oil
6.0 parts of dearomatised hydrocarbon solvent

The two phases were mixed together in a reactor in a ratio of 1 part oil phase to 1 part aqueous phase under high shear to form a water-in-oil emulsion. Then this water in oil emulsion was sparged with nitrogen to remove oxygen.

Polymerisation was run by addition of a redox couple of sodium metabisulphite and tertiary butyl hydroperoxide in solution in water.

After rising the maximum temperature (adiabatic polymerisation), the emulsion was held at 65° C. for 60 minutes.

Vacuum distillation was carried out to remove water and volatile solvent to give a final product of 58% polymer solids.

The last step consisted of adding oil in water emulsifier to make the liquid dispersion ready to use. To 100 parts of distilled product 6.0 parts of ethoxy-lated fatty alcohol were then added.

### Example 2

### Preparation of Composition 1 in Accordance with the Invention, Comparative Compositions A-C and a Control Composition

The compositions were prepared using the following process:
1. Heat water to 45° C. with stirring.
2. Add the polymer slowly over about 1 minute.
3. Mix for about 12 minutes.
4. Add minor ingredients.
5. Melt the softening active and fatty alcohol at 60° C. to form a co-melt.
6. Add molten active
7. Add the HCl to a target pH of 2.5.
8. Add dyes and perfumes.
9. Cool to 30° C.

Alternatively, the HCl was added with the minor ingredients at step 5.

The resulting compositions are shown in Table 1 below.

TABLE 1
Compositions of the liquid fabric softeners 1, A-C and the control.

| | Level of | | | | | |
|---|---|---|---|---|---|---|
| | water soluble | | | | | |
| Ingredient | polymer | | | | | |
| (wt %) | chains (%) | A | B | C | 1 | Control |
| Active¹ | not | 2.96 | 2.96 | 2.96 | 2.96 | 2.96 |
| | applicable | | | | | |
| Fatty | not | 0.49 | 0.49 | 0.49 | 0.49 | 0.49 |
| alcohol² | applicable | | | | | |
| perfume³ | not | 0.28 | 0.28 | 0.28 | 0.28 | 0.28 |
| | applicable | | | | | |
| Polymer⁴ | 40.3 | 0.15 | — | — | — | — |
| Flosoft222 | | | | | | |
| Polymer⁴ | 32.1 | — | 0.15 | — | — | — |
| Flosoft A | | | | | | |
| Polymer⁴ | not known | — | — | 0.15 | — | — |
| Flosoft C | | | | | | |
| Polymer⁴ | 12.3 | — | — | — | 0.15 | — |
| Flosoft D | | | | | | |
| Dye⁵ | not | 0.0076 | 0.0076 | 0.0076 | 0.0076 | 0.0076 |
| | applicable | | | | | |
| HCl | not | to pH | to pH | to pH | to pH | to pH |
| | applicable | 2.5 | 2.5 | 2.5 | 2.5 | 2.5 |
| Water & | not | to 100 | to 100 | to 100 | to 100 | to 100 |
| minors⁶ | applicable | | | | | |

¹SP88 - Palm based soft TEA Quat; ex Stepan
²Stenol 1618; ex Cognis
³MJ Pink Stardust
⁴ex-SNF
⁵Liquitint dyes
⁶Antifoam, preservative, sequestrant, etc

### Example 3

### Viscosity of Composition 1, Comparative Compositions A-C and the Control Composition

The viscosities of the compositions were measured as follows:—

The instrument used was a Haake VT550 with MV1 cup and rotor set. The measurements were carried out at 25° C. and a rotor speed of 106 s−1 was used. The reading was taken after 30 seconds.
1) About 30 ml of the composition was added to the MV1 cup.
2) The cup was then placed into a water bath to equilibrate to 25° C.
3) The rotor was attached and the cup carefully positioned for measurement on the Haake and secured with a collar.
4) Any excess product was removed from the top of the rotor with a plastic pipette.
5) The viscosity was then measured, thermostatically controlled at 25° C., using setting 5, (106 s−1).
6) A reading was taken after 30 seconds.
7) The viscosity units used were mPas·s

The results are given in Table 2 below:—

TABLE 2
Viscosity of fabric conditioner compositions 1,
A-C and the control.

| | Viscosity |
|---|---|
| Composition | (mPas · s) |
| A | 63 |
| B | 85 |
| C | 60 |
| 1 | 98 |
| Control | 17 |

It will be seen that the composition in accordance with the invention has a significantly higher viscosity than the other compositions, resulting from the same amount of polymer.

### Example 4

### Redeposition studies for Composition 1, Comparative Compositions A and B and the Control Composition

Each composition was evaluated for its redeposition properties as follows:—

Soil redeposition performance was measured in a standard multi-wash test.

Conditions which result in high carryover of main-wash liquor into the final rinse have been found to be most sensitive to soil redeposition effects. Particularly sensitive are wash conditions where only one rinse is used. Thus, a top loading automatic washing machine was used, which utilised only a single rinse.

Clean ballast load (white cotton terry) was added to the washing machine and soil added to the wash in the form of standard soil ballast fabrics comprising a mixture of SBL2004 standard soil ballast cloths and proprietary soil ballast cloths. Five cloths of each type were added giving a total soil loading per wash of approximately 80 g.

A commercially available detergent formulation (Omo Multi Acao) was added to the main wash at the recommended dosage. Fabric conditioners, in accordance with the invention, was dosed into the final rinse, at standard dosage.

Soil redeposition was measured as the loss of reflectance at 460 nm (R*₄₆₀) after multiple washes on the initially clean white monitor fabrics. Loss of reflectance, that is lower R*₄₆₀ values, indicated higher levels of soil redeposition. Visual observation was used to assess the unevenness of the soil deposition.

The soil redeposition results are shown in Table 3 below:

TABLE 3
Soil redeposition on white cotton terry (after 10 wash cycles) by fabric
conditioner compositions 1, A, B and the control.

| | R*₄₆₀ | | Uneven soil |
|---|---|---|---|
| Product | Initial | R*₄₆₀Final | deposition |
| Control | 89.97 | 85.46 | None¹ |
| Composition 1 | 89.97 | 84.39 | None¹ |
| A | 89.97 | 81.54 | High³ |
| B* | 88.97 | 84.74 | Low to medium² |
| A* | 88.97 | 82.58 | High³ |

*Level of polymer used was 0.12
¹No uneven deposition of soil
²Some uneven soil deposition
³Very uneven soil deposition

These results show that the composition in accordance with the invention results in much reduced reflectance loss as well as no unevenness of soil redeposition when compared to other polymers.

1. A fabric conditioning composition comprising a polymer and a fabric softening active, characterised in that the polymer is a crosslinked water swellable cationic copolymer of at least one cationic monomer and optionally other monomers selected from non-ionic and anionic monomers, characterized in that the polymer comprises less than 25% of water soluble polymeric chains, by total weight of the polymer, and a cross-linking agent concentration of from 500 ppm to 5000 ppm relative to the polymer.

2. A composition as claimed in claim 1 wherein the polymer is a copolymer of acrylamide and trimethylaminoethylmethacrylate chloride.

3. A composition as claimed in claim 1, wherein the polymer comprises less than 20%, preferably less than 15% of water soluble polymeric chains, by total weight of the polymer.

4. A composition as claimed in claim 1 wherein the fabric softening active is a quaternary ammonium compound.

5. A composition as claimed in claim 4, wherein the quaternary ammonium compound is an ester-linked compound.

6. A composition as claimed in claim 5, wherein the ester-linked compound is an ester-linked triethanolamine quaternary ammonium compound comprising unsaturated fatty chains.

7. A composition as claimed in claim 1, wherein the fabric softening active is present in an amount of from 9 to 20 wt %, by weight of the total composition.

8. A composition as claimed in claim 7, wherein the polymer is present in an amount of from 0.01 to 0.2 wt %, preferably from 0.02 to 0.1 wt %, by weight of the total composition.

9. A composition as claimed claim 1, wherein the fabric softening active is present in an amount of from 2 to 8 wt %, by weight of the total composition.

10. A composition as claimed in claim 9, wherein the polymer is present in an amount of from 0.001 to 0.5, preferably from 0.15 to 0.35 wt %, by weight of the total composition.

11. A process for preparing a composition as defined in claim 1 which comprises the steps of:—
heating water to a temperature of from 40 to 50° C.; adding the polymer to the water and mixing; melting the softening active to form a melt; adding the melt to the water; and then adjusting the pH.

12. Use of a composition as claimed in claim 1 to condition textiles.

13. Use of a crosslinked water swellable cationic copolymer as defined in claim 1 to in a fabric conditioning composition.

14. Use as claimed in claim 13 to thicken a fabric conditioning composition.
